(19) United States
(12) Patent Application Publication
(10) Pub. No.: US 2012/0322019 A1
(43) Pub. Date: Dec. 20, 2012

(54) Customized Orthodontic Arch Wire Manufactured Using Model of Patient's Teeth

(75) Inventor: Paul E. Lewis, Midvale, UT (US)

(73) Assignee: ULTRADENT PRODUCTS, INC., South Jordan, UT (US)

(21) Appl. No.: 13/574,344

(22) PCT Filed: Jun. 21, 2010
(86) PCT No.: PCT/US10/39314

§ 371 Date: Aug. 31, 2012

Related U.S. Application Data
(60) Provisional application No. 61/297,352, filed on Jan. 22, 2010.

(51) Int. Cl. A61C 7/28

(52) U.S. Cl. 433/10; 433/24

(57) ABSTRACT

Customized low force orthodontic arch wires include a core wire (102) formed of a shape memory material and a plurality of bracket engagement blocks (104) disposed in spaced apart relationship along the length of the core wire (102). The particular position of each engagement block (104) along the length of the core wire (102), as well as the length and curvature of the core wire (102), are customized for the particular patient on which the arch wire is to be installed. A physical or electronic custom model of the patient's dental arch is obtained. The customized arch wire is then fabricated according to the specifications determined by reference to the custom model of the patient's teeth.

### BACKGROUND OF THE INVENTION

1. The Field of the Invention

The present invention relates to arch wires for use with orthodontic brackets in correcting spacing and orientation of the teeth.

2. The Relevant Technology

Orthodontics is a specialized field of dentistry that involves the application of mechanical forces to urge poorly positioned or crooked teeth into correct alignment and orientation. Orthodontic procedures can be used for cosmetic enhancement of teeth, as well as medically necessary movement of teeth to correct overjets and/or overbites. For example, orthodontic treatment can improve the patient's occlusion, or enhanced spatial matching of corresponding teeth.

The most common form of orthodontic treatment involves the use of orthodontic brackets and wires, which together are commonly referred to as “braces.” Orthodontic brackets are small slotted bodies configured for direct attachment to the patient's teeth or, alternatively, for attachment to bands which are, in turn, cemented or otherwise secured around the teeth. Once the brackets are affixed to the patient's teeth, such as by means of glue or cement, a curved arch wire is inserted into the bracket slots.

The brackets and the arch wire cooperate to guide corrective movement of the teeth into proper alignment. Typical corrective movements provided by orthodontic treatment can include torque, rotation, angulation, leveling, and other movements needed to correct the spacing, and alignment of misaligned teeth. Torque refers to movement (i.e., tipping) of the tooth in a labial or lingual direction. Rotation refers to rotational movement of the tooth about the tooth's longitudinal axis. Angulation refers to angular movement of the tooth about an axis passing essentially perpendicularly through the labial tooth surface in order to bring the occlusal edge of the tooth in line with the occlusal plane of the dental arch. Angulation therefore refers to angular movement of the tooth in a mesial-distal direction or distal-mesial direction relative to the occlusal edge of the tooth. Leveling relates to moving the occlusal edges of the teeth up or down and into proper alignment.

Arch wires typically have either a square, rectangular, or round cross-section. Square and rectangular cross-sections allow the arch wire to be used to apply a torquing force when engaged in an arch wire slot of an orthodontic bracket. Although a relatively thinner wire having a round cross-section does not allow application of torquing forces when engaged within an arch wire slot, it does provide a greater degree of flexibility and generally applies less force in use, which is more comfortable for the patient. The characteristic low force of round arch wires is due to their thinner cross-section. As such, wires having a round cross-section are often useful during the beginning stages of orthodontic treatment when the teeth are most mal-aligned. Use of a round arch wire allows for movement of teeth to correct mainly angulation, rotation and spacing of a patient's teeth with relatively light (and therefore more comfortable) forces.

Once these corrections have been achieved, a relatively thicker square or rectangular wire typically replaces the round arch wire so as to allow torquing of selected teeth to complete the treatment. In addition to being square or rectangular in cross-section, these arch wires are also thicker so as to limit any “play” of the arch wire within the slot of the bracket. Limiting this play increases the forces (as a result of increased arch wire thickness) applied by the wire and also increases engagement between the arch wire and the bracket slot. Such engagement is important in achieving the desired movement of the teeth. Because of these characteristics, in a typical orthodontic treatment a patient may typically require 6-9 different arch wires that are used progressively, beginning with relatively thin light force round arch wires and progressing towards stiffer, thicker square or rectangular arch wires.

### BRIEF SUMMARY OF THE INVENTION

The present invention is directed to methods of manufacturing and using customized low force orthodontic arch wires. The custom arch wires may be capable of applying torquing and/or other corrective forces early in orthodontic treatment. The customized low force arch wire includes a core wire formed of a material having shape memory that extends along a generally curved arch wire axis between a first end and a second end. The arch wire further includes a plurality of bracket engagement blocks disposed in spaced apart relationship along the length of the core wire. The spacing between each block (i.e., its particular position along the core wire length), as well as the length of the core wire are customized for the particular patient on which the arch wire is to be installed. Each engagement block is configured for placement within the slot of a corresponding orthodontic bracket with which it works to move the teeth in a desired direction. The engagement blocks are advantageously enlarged relative to the core wire (i.e., the cross-sectional width of the engagement blocks is greater than the cross-sectional width of the core wire), providing for better engagement between any given engagement block and its corresponding bracket slot as compared to if the engagement blocks were not present.

In one embodiment, a physical or electronic custom model of the patient's dental arch is obtained and used to manufacture one or more customized orthodontic arch wires. Based on the custom model, a corrected, final position of the patient's teeth is determined. A custom arch wire is then formed according to the custom specifications derived from the custom model. For example, a core wire and a plurality of engagement blocks may be provided, and the appropriate length of the core wire is determined by reference to the custom model of the patient's dental arch. Based upon the corrected, final position of the patient's teeth (by reference to the custom model), a position for each bracket engagement block is determined, and the engagement blocks are positioned along the length of the core wire at the predetermined positions so that the engagement blocks may be received within a corresponding slot of an orthodontic bracket during orthodontic treatment of the patient.

In one embodiment, the engagement blocks and core wire may all be formed simultaneously as a single integral piece of material. For example, metal injection molding can be used to integrally mold the core wire having appropriately positioned engagement blocks connected by molded “wire” sections. In other words, the core wire and engagement blocks may be molded together as a single integral piece. According to another alternative, the engagement blocks and core wire may be formed from a single integral piece of material removing material adjacent to the core wire by machining and/or by chemical etching.

Regardless of the method of manufacture, the positioning of each engagement block along the core wire, including spacing between individual engagement blocks, as well as the overall length of the core wire itself, are customized to the particular patient. Such customization provides the best possible fit between the arch wire, engagement blocks, and brackets, improving the efficiency of the orthodontic treatment. In addition, the enlarged engagement blocks provide for increased surface contact and engagement between the bracket slot and arch wire than would otherwise occur if the blocks were absent. This improved engagement and reduced play of the arch wire in the bracket slot results in better application of corrective forces over a longer period of time. For example, a typical patient may visit the orthodontic practitioner about once every 6 weeks to have adjustments in the arch wire and/or brackets made. Application of corrective forces is best just after the adjustments are made. Because of play between the arch wire and bracket slot, a typical arch wire loses its ability to effectively transfer forces to the bracket and teeth as the teeth begin to move. Another adjustment is necessary.

Typically, the vast majority of corrective movement occurs for only about 2 weeks after adjustment. After this point, because of play between the arch wire and bracket slots, little movement occurs. This period of time, which may be as much as about 4 weeks of a 6 week adjustment interval, is mostly wasted. Corrective movement that lasts longer than this typical 2 weeks may be possible by using a larger, stiffer arch wire (which reduces play between the bracket slot and arch wire). However, stiffer arch wires are uncomfortable for the patient, and may also actually increase overall treatment time as recent studies have shown that consistent low force application actually moves the teeth faster than high forces from stiffer arch wires.

In contrast, the thin core wire portions of the arch wire advantageously result in an arch wire with relatively low stiffness, so that the arch wire applies low corrective forces to the brackets and teeth. These characteristic low forces result in decreased treatment time, as the teeth tend to move faster under application of such forces. This unique combination of low stiffness coupled with the enlarged engagement blocks allows for corrective forces to be relatively small, comfortable, and more efficient, providing excellent engagement (i.e., reduced play) between the arch wire and the bracket slots. This combination of better engagement, reduced play, and continuous low force advantageously allows for significant reduction in treatment times.

According to one embodiment, at least some of the engagement blocks will have a rectangular (e.g., square) cross-section. Some of the engagement blocks (e.g., corresponding to the rearward oriented teeth) can have a round (e.g., circular) cross-section. Rounded blocks do not provide a torque value but may be beneficial for use with teeth requiring no torque movement (e.g., molars and/or bicuspids) owing to reduced friction between rounded engagement blocks and brackets compared to rectangular blocks.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A is a perspective view of a custom model of a patient's dental arch;

FIG. 1B is a top view of the custom model of FIG. 1A next to a core wire, the length of the core wire being determined (and cut to custom length) by reference to the custom model;

FIG. 2 is a close up perspective view of two adjacent teeth showing how the spacing between engagement blocks is customized so that the blocks are aligned with the brackets attached at the center of each tooth;

FIG. 3A is a perspective view of an exemplary customized low force orthodontic arch wire having bracket engagement blocks disposed along the length of the arch wire;

FIG. 3B is a cross-sectional view of the arch wire of FIG. 3A along lines 3B-3B;

FIGS. 3C and 3D illustrate an exemplary customized arch wire in which some of the engagement blocks are round rather than rectangular;

FIG. 4A is a perspective view of an alternative customized low force orthodontic arch wire having engagement blocks disposed along the length of the arch wire;

FIG. 4B is a cross-sectional view of the arch wire of FIG. 4A along lines 4B-4B;

FIGS. 4C and 4D illustrate an exemplary arch wire in which some of the engagement blocks are round rather than rectangular;

FIG. 5 illustrates an exemplary arch wire having differently-sized interconnecting wires between engagement blocks;

FIG. 6 illustrates a round engagement block having ramped rather than square ends;

FIG. 7A is a side view of an exemplary low force orthodontic arch wire in which an engagement block is engaged within a corresponding bracket, and in which there is some play between the engagement block and the bracket slot;

FIG. 7B is a side view of an alternative exemplary low force arch wire in which an engagement block is engaged within a corresponding bracket and in which there is substantially no play between the engagement block and the bracket slot;

FIG. 7C is a side view of an alternative exemplary engagement block having a round rather than square cross-section engaged within a corresponding bracket;

FIG. 8 is a perspective view of a pair of mandibular and maxillary low force orthodontic arch wires engaged with corresponding brackets;

FIG. 9A illustrates the plurality of teeth having orthodontic brackets installed thereon; and

FIG. 9B illustrates an exemplary arch wire assembly having built in prescription features inserted within a slot of each of the orthodontic brackets.

### DETAILED DESCRIPTION OF THE PREFERRED EMBODIMENTS

### I. Introduction

In one embodiment of the present method, a physical or electronic custom model of the patient's dental arch is obtained and used to manufacture a customized arch wire having a size and spacing between engagement blocks that match the patient's unique dentition. Based on the custom model, a corrected, final position of the patient's teeth is determined. A custom arch wire is then formed by reference to the custom model so that the arch wire specifications are as dictated by the custom model. For example, the appropriate length of the core wire and the particular positioning (i.e., spacing) of each engagement block along the core wire is determined by reference to the custom model. As such, the manufactured custom arch wire is specifically customized for the use of an individual patient.

### II. Exemplary Customized Low Force Orthodontic Arch Wires

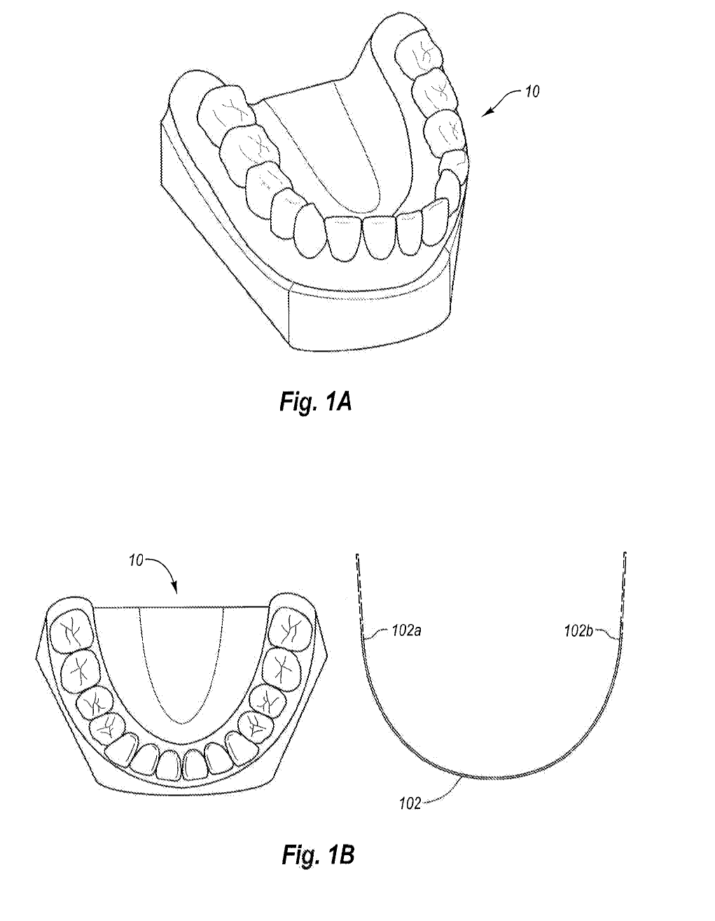

FIG. 1A illustrates an exemplary custom model 10 of a patient's dental arch. The custom model may be obtained by taking an impression of the patient's teeth (e.g., with an alginate or other impression material), and then preparing a custom model from the taken impression. Alternatively, the custom model may be prepared by electronically scanning the patient's dental arch and creating an electronic digital representation of the dental arch from the scanning data. The size of the arch, as well as the size, positioning, and orientation of individual teeth are all represented by the custom model. Once the impression of the dental arch with misaligned teeth is taken, or the scanning data of such an arch is obtained, the misalignment of individual teeth within the model is corrected, so that the finished custom model is substantially an exact representation of the patient's dental arch as it will or should exist at the end of orthodontic treatment (i.e., after the misaligned teeth have been moved). It is by reference to this finished custom model 10 that the custom low force arch wire is manufactured.

As shown in FIG. 1B, the length of the core wire (i.e., from first end 102a to second end 102b) is determined by reference to the previously obtained custom model 10 of the dental arch. The length may vary depending on characteristics of the patient's dental arch. In addition, the curvature of the core wire 102 (i.e., the radius of the curvature corresponding to the width of the dental arch) may also be customized by reference to model 10 so as to provide for a substantially exact fit. For example, a child or adolescent's dental arch may be significantly smaller (e.g., including a shorter length and width) as compared to a dental arch of an adult. Furthermore, the relative sizes of dental arches between individuals of the same age may vary (e.g., depending on the genetics or other factors unique to the patient).

Providing the core wire with a custom length and width (i.e., curvature) intended to exactly fit the particular patient's individual, custom dental arch results in a better fit and increased comfort (e.g., less tendency for an overly long wire to extend into sensitive internal oral tissues) as compared to a one-size fits all arch wire length. For example, as shown in FIG. 1B, core wire 102 may be cut from a longer length of wire to the desired custom length by reference to the length of the individual's dental arch. Portions of wire that lie beyond ends 102a and 102b (before being cut to the customized length) are shown in phantom in FIG. 1B. Formation of the custom width and curvature may be accomplished by bending and/or heat treating the core wire as will be known to those skilled in the art. Alternatively, core wire 102 and the engagement blocks may be formed integral with one another, from a single piece of material (e.g., by metal injection molding, by machining, and/or by chemical etching).

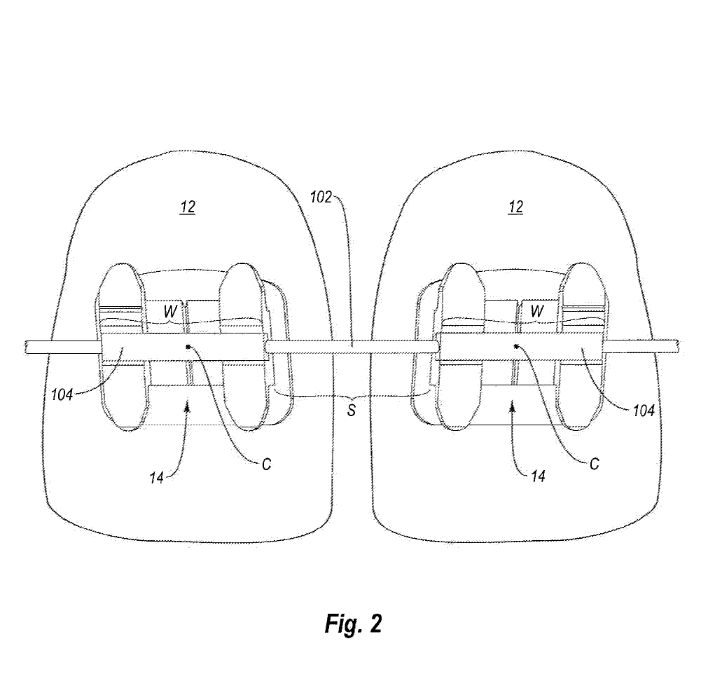

FIG. 2 is a close up perspective view of two adjacent teeth 12, illustrating how the spacing between the engagement blocks 104 (i.e., the positioning of each block 104 along the core wire 102) is customized to the particular patient. As seen in FIG. 2, each bracket 14 is attached to its respective tooth 12 at center point C. Engagement blocks 104 are provided with a width W approximately equal to the width of bracket 14. Importantly, the spacing S between illustrated adjacent blocks 104 is determined by reference to the custom model 10 so as to be customized to accommodate the width of the patient's teeth 12. For example, if the spacing S were not customized, the engagement blocks 104 would likely not be substantially exactly aligned with brackets 12, which are attached to the center C of each tooth. For a patient having relatively wide teeth, the customized spacing S will be greater than for a patient having average width or narrow width teeth. Customizing the spacing between the blocks allows the customized arch wire to be aligned with brackets 12. Because of this customized alignment, the block 104 will be centered along the center of the tooth C. In embodiments where each block 104 has substantially the same width as the corresponding bracket 14, block 104 will be co-terminal at the mesial and distal sides of the corresponding bracket 14.

Customization of block spacing S prevents blocks 104 from being misaligned relative to each bracket slot. In other words, because brackets 14 are attached to the center of each tooth, a non-custom generic arch wire with engagement blocks would include some misalignment between the engagement blocks and the corresponding brackets because each of the patient's teeth may have a width that is not exactly matched to the spacing provided between engagement blocks of the non-custom generic arch wire. As such, many of the blocks may not be centered within the corresponding bracket at the center of the tooth, and many of the blocks may extend out one side or the other of the bracket slot. Because the inventive arch wire is customized, such misalignment issues are prevented, resulting in improved fit between the arch wire engagement blocks and the brackets. Such improved fit and alignment will result in increased comfort, more efficient application of corrective forces, and reduced treatment times.

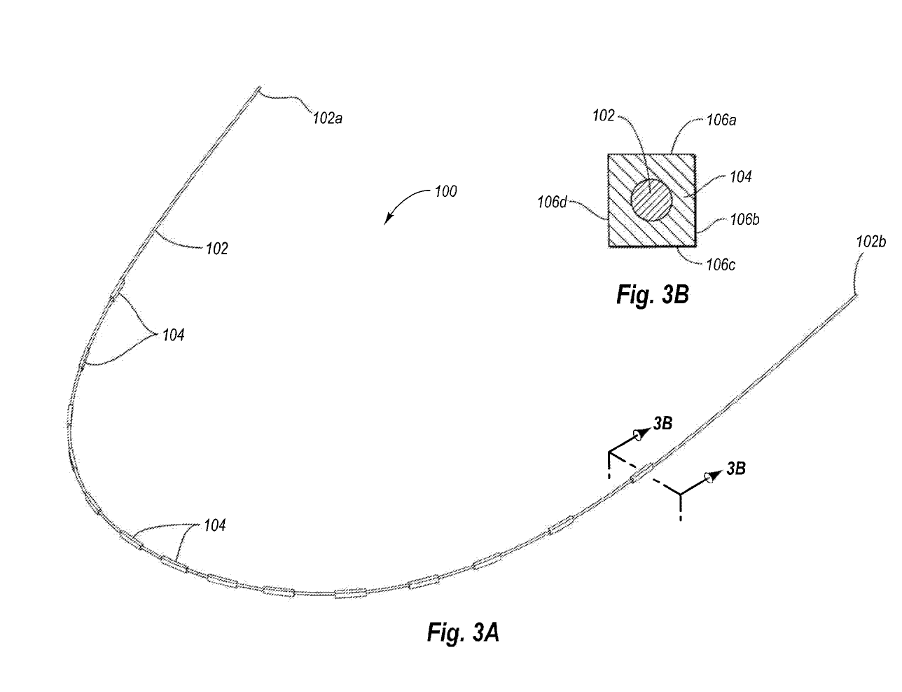

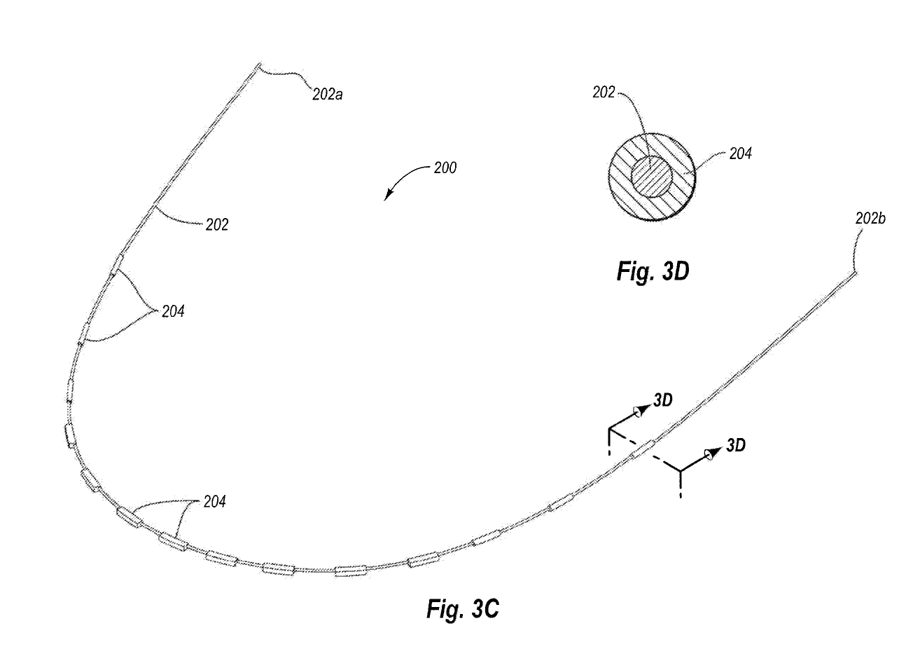

FIGS. 3A-3B illustrate an exemplary custom orthodontic arch wire 100 that may be manufactured according to the inventive method. The orthodontic arch wire 100 includes core wire 102 and a plurality of spaced apart engagement blocks 104 disposed along the core wire 102. The particular positioning of each engagement block 104 along core wire 102 is customized to the patient's dental arch by reference to the custom model 10 so that each engagement block 104 is positioned in the precisely desired position for engagement with a bracket slot affixed to its corresponding tooth during treatment. As shown, the engagement blocks 104 have a diameter that is greater than the diameter of adjacent segments of the core wire 102. In one embodiment, engagement blocks 104 may be provided separately from core wire 102 and then positioned in the custom, predetermined positions by reference to custom model 10. If it is desired to fix blocks 104 relative to core wire 102, they may be crimped in place (e.g., with pliers), welded, brazed, or otherwise fixedly attached to core wire 102. Of course, in embodiments in which core wire 102 and blocks 104 are integrally formed together from a single piece of material, they will already be fixed in place.

As described above, a determination is made relative to the positioning of each engagement block 104 relative to core wire 102 by reference to the custom model 10 obtained previously. As such, the positioning of each engagement block is precisely determined so that the engagement block will be aligned with the orthodontic bracket and tooth to which it corresponds. Such a customization of the position of each block 104 (and therefore the spacing between adjacent blocks 104) allows for precise matching and alignment of the block with the slot of the corresponding orthodontic bracket. As will be apparent to one of skill in the art, this will provide a better fit between the arch wire engagement blocks 104 and each orthodontic bracket as compared to a system employing an off the shelf “one-size fits all” type standardized arch wire including engagement blocks.

The actual manufacture of the customized low force orthodontic arch wire may occur within a controlled dental laboratory setting, in which the parameters defining the custom arch wire are provided to the fabrication lab (e.g., by reference to an electronic or physical custom model). Such a method would provide for the best possible quality, as skilled and experienced technicians using specifically tailored equipment would fabricate each custom arch wire. Alternatively, the manufacture could be performed by the patient's orthodontic practitioner, which may provide for faster fabrication. For example, a practitioner could obtain a custom model of the patient's dental arch, determine the required core wire length, cut the appropriate length from a longer wire, set the core wire curvature and width by bending and/or heat treatment, determine custom placement of the engagement blocks by reference to the custom model, and crimp provided engagement blocks at predetermined positions. Complete fabrication of the custom arch wire could perhaps be accomplished while the patient waits.

As illustrated in FIG. 3A, core wire 102 can be a single strand of wire that extends between first end 102a and second end 102b. Core wire 102 is preferably formed using a shape memory alloy (SMA) such as a nickel-titanium alloy. SMAs have a shape memory effect in which they can be made to remember a particular shape. Once a shape has been remembered, the SMA may be bent out of shape or deformed and then returned to its original shape by unloading the deformation force. Heating may be used to reset the shape memory of the alloy (e.g., a straight wire may be heated while bent to cause it to then remember the new bent shape).

Exemplary classes of SMAs are as follows: copper-zinc-aluminum; copper-aluminum-nickel; and nickel-titanium (“NiTi”) alloys (e.g., Nitinol). Cobalt-chromium-nickel alloys and cobalt-chromium-nickel-molybdenum alloys (known as Elgiloy alloys) are similar to SMAs in that they have a high modulus of elasticity and they can be used in many similar applications. However, unlike SMAs, cobalt-chromium-nickel alloys and cobalt-chromium-nickel-molybdenum can be permanently deformed without the application of heat by exceeding the modulus of elasticity. The temperatures at which SMAs and similar alloys change their crystallographic structure are dependent on the particular alloy, and can be fine tuned by varying the elemental ratios or by varying the conditions of manufacture. Although perhaps less preferred, chromium-nickel alloys and cobalt-chromium-nickel-molybdenum Elgiloy alloys are within the scope of the term “shape memory materials”, and may be used in the manufacture of the inventive arch wires.

Core wire 102 is shown as including a round (e.g., circular) cross-section of constant diameter from first end 102a to second end 102b. Although this is currently preferred, it will be understood that alternative embodiments may include a core wire of non-round cross-section, e.g., square or rectangular, other polygonal shapes, other rounded wires (e.g., of oval cross-section), or a more complex shape including both straight sides and rounded sides. In addition, core wire 102 can have a constant diameter or it may have a diameter that varies between different engagement blocks so as to provide a desired level of force on adjacent engagement blocks. Exemplary diameters for a round core wire 102 may range from about 0.1 mm to about 0.5 mm. Typical wire diameters include, but are not limited to about 0.1 mm, about 0.15 mm, about 0.2 mm, about 0.25 mm, about 0.3 mm, about 0.35 mm, about 0.4 mm, about 0.45 mm, and about 0.5 mm. Any of the foregoing values may serve as range endpoints.

As shown in FIG. 3A, engagement blocks 104 are disposed on core wire 102 in a spaced apart arrangement. Each block 104 is positioned on core wire 102 in a position corresponding to the location of an orthodontic bracket to which the block 104 corresponds. This position is determined by reference to custom model 10 so that each block 104 is aligned with its corresponding tooth. The length of each individual block 104 may also be customized by reference to custom model 10 so as to provide a suitable length for sliding within a corresponding bracket slot. The length of any individual block (or even its presence at all) may be customized so as to account for initial crowding between adjacent teeth. For example, if two adjacent teeth are closely crowded so as to make it difficult to access and bond brackets to the labial surface of both teeth, it may be desired to limit the length of the individual blocks at these tooth locations, or even to omit one of the engagement blocks until one of the teeth can be moved somewhat away from the other tooth. At that stage, the omitted engagement block could then be crimped or otherwise attached to the core wire or a new custom arch wire could be employed.

Illustrated blocks 104 have a generally rectangular or square cross-sectional shape that allows the engagement blocks 104 to exert torquing forces against the teeth via the orthodontic bracket slots. Of course, all other corrective forces (e.g., tipping and rotation as well as leveling/aligning and spacing forces) can also be applied by blocks 104. The ability of the round core wire 102 to apply torquing forces through blocks 104 is a distinct advantage over existing low force round (e.g., circular) wires. As will be discussed below, some of the engagement blocks can have a round cross-section rather than a rectangular (e.g., square) cross-section.

The diameter of core wire 102 affects the forces that are applied to the teeth, such that different diameters may be appropriate at different stages of treatment where multiple wires are used progressively through treatment. If desired, multiple custom arch wires may be fabricated and employed. For example, the lightest wire forces using a thinner gauge wire (e.g., about 0.1 mm or about 0.15 mm) may be most appropriate at an early stage of treatment, whereas a somewhat heavier wire (e.g., about 0.25 mm) may be appropriate at a later stage of treatment. Multiple progressively employed arch wires would of course be customized to the individual patient as described above (i.e., customized positioning of each engagement block as well as customized core wire length and curvature).

Because the system allows for full or nearly full engagement between the bracket slot and the arch wire (as a result of the enlarged engagement blocks), it may be possible to complete treatment or nearly complete treatment with only a single custom low force arch wire including a core wire of thin cross-section. This ability of the low force arch wire 100 to provide full or nearly full engagement with the bracket slot by means of the engagement blocks 104 is another distinct advantage over existing low force round wires. As such, a single custom arch wire may be sufficient for many treatments.

For example, it may be possible to use a single low force arch wire throughout the entire treatment that includes a core wire cross-section that is not greater than about 0.25 mm, and more preferably that is between about 0.1 mm and about 0.2 mm. Normally it is not possible to use such a thin wire and achieve satisfactory results because such a wire is round and incapable of applying torquing forces, and because such a thin wire results in significant play between the bracket slot (which typically measures either 0.018 inch or 0.022 inch in width). The presence of engagement blocks 104 reduces or eliminates play between the bracket slot and arch wire, all while providing the arch wire 100 with low force characteristics as a result of thin core wire 102.

FIG. 3B illustrates a cross-sectional view of the orthodontic arch wire 100 of FIG. 3A along lines 3B-3B. In particular, FIG. 3B illustrates a cross-sectional view of core wire 102 and an engagement block 104. The exemplary engagement block 104 illustrated in FIG. 3B has a generally square cross-sectional profile with the core wire 102 running through the center. One will appreciate, however, that other shapes (e.g., rectangular or round) for engagement block 104 are possible and that the core wire 102 does not necessarily need to run through the center of the engagement block 104. The illustrated example of engagement block 104 includes four faces 106a-106d. Faces 106a and 106c are gingival/occlusal faces, 106b is a buccal face, and 106d is a lingual face.

The width of engagement block 104 may be sized to substantially fill the width of a typical bracket slot (e.g., 0.018 inch or 0.022 inch). Such an engagement block width will reduce or eliminate play between the block 104 and the corresponding bracket slot. The enlarged characteristic of block 104 relative to core wire 102 allows core wire 102 to be relatively thin, which provides the arch wire with low force characteristics. At the same time, the enlarged block 104 is able to engage fully or nearly so within the corresponding bracket slot, reducing play between the arch wire 100 and each bracket.

This provides the advantages of a thin round low force arch wire and a thick stiff finishing arch wire within the same arch wire. Advantageously, the inventive arch wire can be used early in treatment to provide early torque correction. In addition, because the wire is low force it is more comfortable for the patient throughout the entirety of treatment, as there is no need to use a relatively thick square or rectangular finishing wire. Furthermore, because the enlarged engagement blocks provide improved engagement between the arch wire and bracket slots, play in the system is reduced. Reduced play results in corrective forces being applied more uniformly over time periods between orthodontist visits when adjustments are made. Such uniformity may result in significantly reduced overall treatment times. For example, when using typical arch wires, because of the play within the system corrective forces may no longer be appreciable about 2 weeks after orthodontist adjustment. Because typical orthodontist visits are about 6 weeks apart, this represents wasted treatment time. The inventive arch wire comfortably applies corrective forces over substantially the entire 6 week interval, significantly speeding up treatment.

Treatment times are further reduced because of the reduction or elimination of the use of relatively thick, stiff rectangular or square finishing arch wires. Recent research has shown that the teeth actually move faster under the influence of light forces as compared to stronger forces. Because the inventive low force arch wire is able to provide the needed torquing forces and full or nearly full engagement between the bracket slot and arch wire with a low force arch wire, it is not necessary to use traditional stiff square or rectangular finishing arch wires.

FIGS. 3C and 3D illustrate an exemplary arch wire assembly 200 in which some of the engagement blocks 204 are round rather than square or rectangular in cross-section. Round engagement blocks do not provide torque control. However, teeth positioned toward the rear of a person's dental arch (e.g., molars and/or bicuspids) typically require little or no torque control to provide proper alignment. Engagement blocks that are round may provide for desired alignment while permitting greater movement of the teeth relative to the engagement blocks since round engagement blocks create less friction with orthodontic brackets compared to square or rectangular engagement blocks.

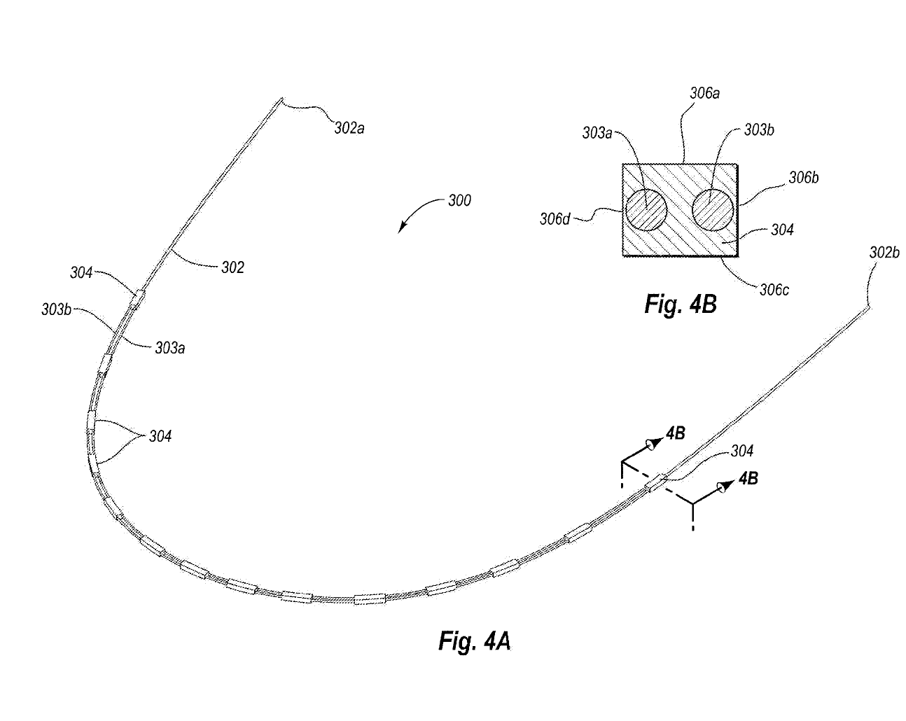

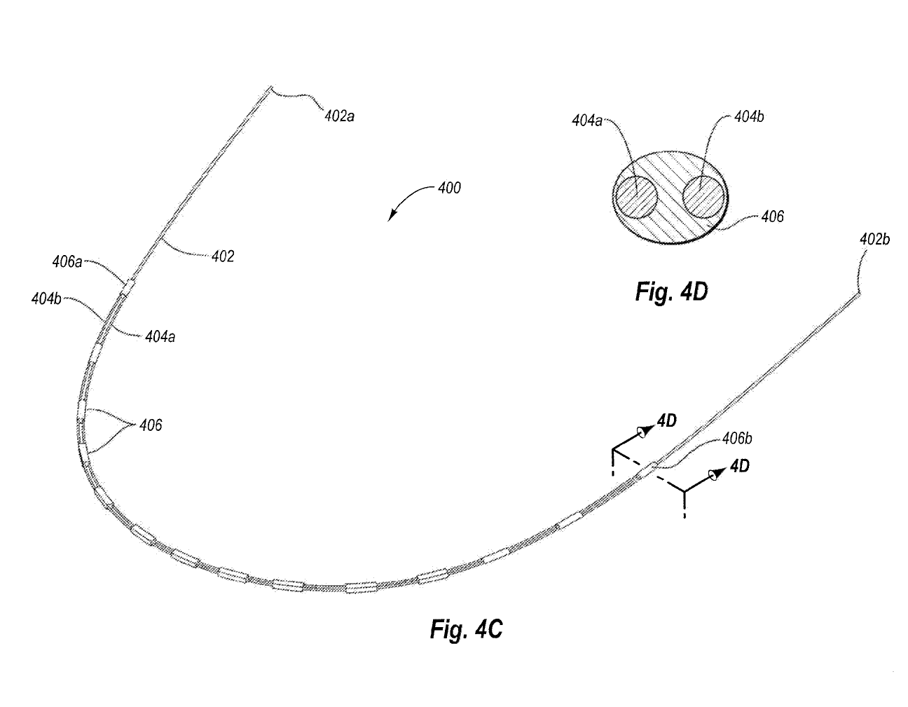

FIGS. 4A-4B illustrate an alternative orthodontic arch wire 300. The orthodontic arch wire 300 shown in FIGS. 4A-4B is similar to arch wire 100 illustrated in FIGS. 3A and 3B, except that engagement blocks 304 are coupled to a single-stranded core wire 302 at the first and second ends 302a and 302b and by dual core wires 303a and 303b throughout a central portion of arch wire 300. In other words, the portion of the arch wire 300 including engagement blocks 304 includes two core wires 303a and 303b.

Arch wires 303a and 303b may be the same diameter or different diameters. Exemplary diameters for core wires 303a and 303b range from about 0.05 mm to about 0.5 mm. Such an embodiment provides a mechanism for increasing the stiffness of the arch wire 300 without necessarily increasing the diameter of either core wire. It also would allow use of very small thickness wires (e.g., two 0.05 mm diameter wires). Such a small thickness single core wire may not provide sufficient force or be so thin as to not have sufficient strength for use in orthodontic treatment. Embodiments which include two core wires exhibit a stiffness and moment of inertia that is significantly less than a similarly sized rectangular wire. The moment of inertia of the arch wire's cross-sectional area is a measurement of the wire's ability to resist bending. The larger the moment of inertia, the less the wire will bend when exposed to a given force (i.e., it will be stiffer). For example, an embodiment including a first core wire (e.g., 303a) having a diameter of about 0.3 mm and a second core wire (e.g., 303b) having a diameter of about 0.4 mm will exhibit less stiffness and a lower moment of inertia than a rectangular arch wire measuring about 0.4 mm in one dimension and about 0.7 mm in the other dimension.

As shown in FIGS. 4A-4B, the engagement blocks 304 disposed on the core wires 303a and 303b are shown as having a generally rectangular shape that allows the engagement blocks 304 to exert forces (e.g., torquing forces) against the teeth via the orthodontic bracket slots. Similar to block 104, engagement block 304 has four faces 306a-306d. Faces 306a and 306c are gingival/occlusal faces, 306b is a buccal face, and 306d is a lingual face. Although illustrated as spaced apart from one another, it will be understood that dual core wires 303a and 303b may contact one another. The selected spacing (if any) between core wires 303a and 303b may affect the stiffness of the arch wire 300.

FIGS. 4C and 4D depict an exemplary arch wire 400 that is similar to arch wire 300 shown in FIGS. 4A and 4B, except that the last three engagement blocks have a round cross-section rather than square or rectangular cross-section. As discussed above, it is typically unnecessary to provide torque control to the more rearward oriented teeth, such as a person's molars and/or bicuspids. Providing engagement blocks with a round cross-section provides desired alignment such as angulation, rotation, leveling, and alignment, but not torque control. It will be appreciated that other engagement blocks along the length of an arch wire can be round rather than square or rectangular to the extent that torque control is not desired or required.

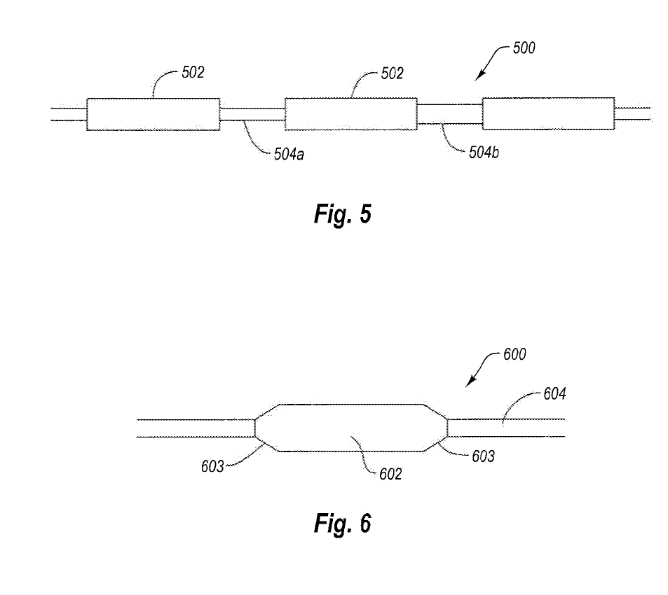

FIG. 5 illustrates a portion of an orthodontic arch wire 500, which includes engagement blocks 502 separated by differently-sized interconnecting core wires 504a and 504b. Differently-sized interconnecting core wires may be advantageous where it is desired that the engagement blocks provide varying levels of force on the brackets. For example, where a tooth is greatly misaligned, it may be desirable to provide greater force compared to a tooth that is better aligned initially. Such variability in the core wire diameter can be made a part of the core wire as dictated by the custom model 10. Varying the core wire diameter at specific locations (e.g., adjacent an engagement block corresponding to a particular tooth) will provide customization of the orthodontic treatment provided by the customized arch wire.

FIG. 6 illustrates a portion of an orthodontic arch wire 600 that includes an engagement block 602 and interconnecting core wire 604. Rather than having a sharp (e.g., square) edge of approximately 90°, as in the arch wires of proceeding embodiments, the engagement block 602 includes ramped surfaces 603 that provide a more gradual transition between engagement block 602 and interconnecting wires 604. Providing a more gradual transition between an engagement block and interconnecting wires can provide greater comfort to the wearer by smoothing out otherwise sharp edges on which the tongue or other sensitive tissues may catch. Ramped transition surfaces can be used in round as well as rectangular or square engagement blocks.

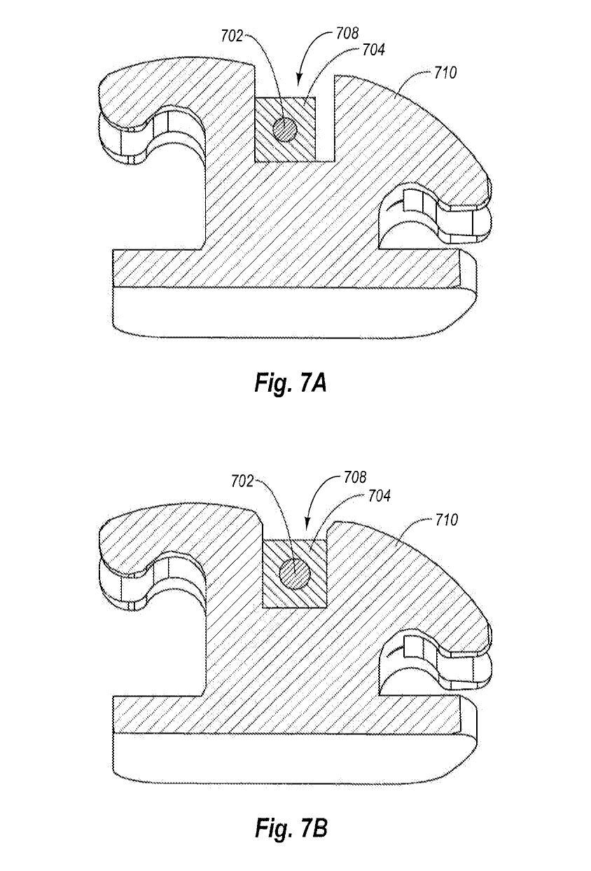

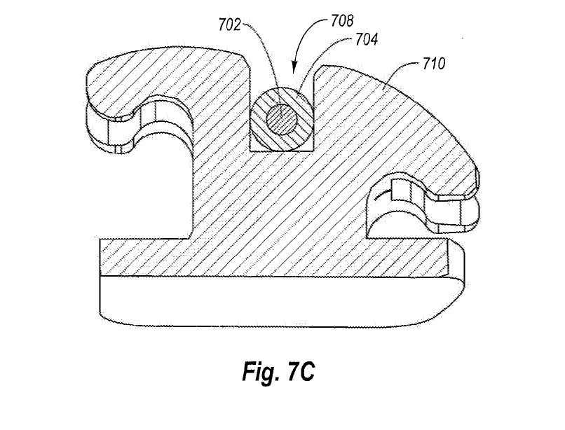

FIGS. 7A-7C illustrate cross-sectional views through exemplary brackets illustrating the reduction in play achieved by the inventive low force orthodontic arch wire. FIG. 7A shows an embodiment in which engagement block 704 is received within the arch wire slot 708 of corresponding orthodontic bracket 710. As shown, engagement block 704 is enlarged relative to core wire 702 so that play between block 704 and bracket slot 708 is reduced as compared to engagement that would otherwise be provided only by core wire 702 within bracket slot 708 if engagement block 704 were not present.

FIG. 7B illustrates a similar view, but in which the occlusal-gingival play between slot 708 and engagement block 704 has been eliminated. The degree of play present between slot 708 and block 704 will depend on the dimensions of block 704 relative to slot 708. In addition, the diameter of core wire 702 is greater in the embodiment of FIG. 7B as compared to 7A. The arch wire of FIG. 7B will exhibit greater stiffness relative to the arch wire of FIG. 7A.

FIG. 7C illustrates a cross-sectional view through an exemplary bracket 710 in which an engagement block 704 having a round cross-section is introduced into arch wire slot 708. The main difference between the embodiment of 7C and those shown in 7A and 7B is that the arch wire having a round cross-section does not provide torque control. An advantage of providing an arch wire engagement block having a round cross-section is that it reduces friction between the engagement block and the bracket, which increases the ability of the bracket to move relative to the round engagement block as compared to a rectangular or square engagement block.

In practice, a practitioner may use a customized inventive arch wire similar to that shown in FIG. 7A or 7C early in treatment. During a later stage of treatment the custom arch wire may be replaced with another custom arch wire similar to that shown in FIG. 7B, which will provide maximum engagement with bracket slot 708, with slightly greater stiffness. The stiffness of the arch wire shown in FIG. 7B will still be significantly less than a traditional square or rectangular finishing arch wire. Alternatively, a low force arch wire as seen in FIG. 7A, 7B or 7C may be used for the entire duration of the orthodontic treatment, as it provides low force as a result of the thin diameter of core wire 702, but provides for excellent slot engagement as a result of engagement block 704. Such a configuration advantageously reduces or may even eliminate the need to use progressively stiffer arch wires during orthodontic treatment (i.e., a single arch wire may suffice).

Although described in the context of typical orthodontic bracket slots that typically have a occlusal-gingival width of either 0.022 inch (0.56 mm) or 0.018 inch (0.46 mm) and a buccal-lingual height of 0.028 (0.70 mm) inch or 0.031 inch (0.79 mm), it will be understood that the dimensions of the low force orthodontic arch wire components (e.g., the core wire(s) and the engagement blocks) may be adapted to suit any other orthodontic bracket system.

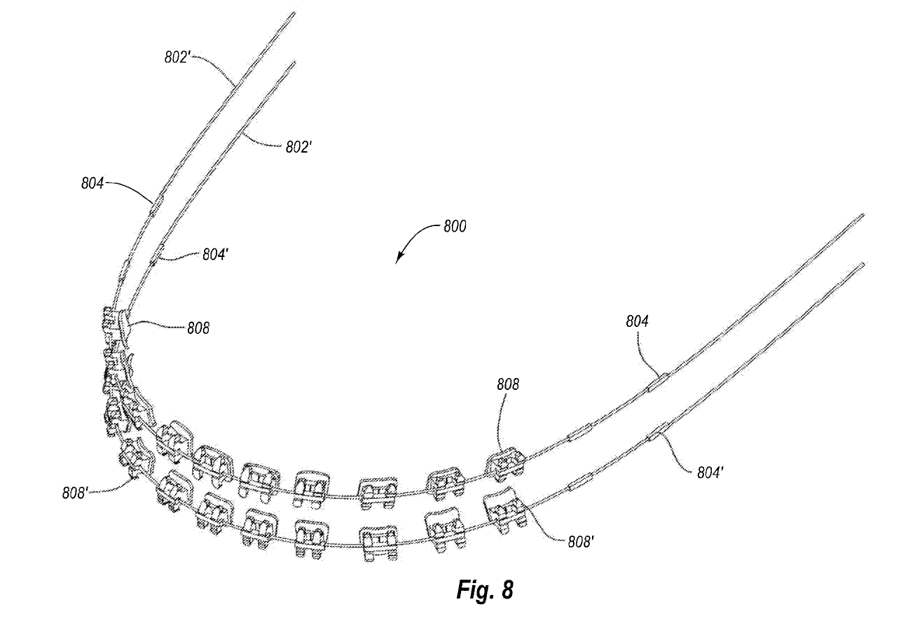

FIG. 8 illustrates a pair of custom fabricated arch wires 800 configured for placement on an upper/mandibular dental arch and a lower/maxillary dental arch. The custom upper wire 802 includes a plurality of spaced apart, enlarged engagement blocks 804, which are engaged within a partial set of orthodontic brackets 808. The custom lower wire 802′ includes a plurality of spaced apart, enlarged engagement blocks 804′, which are engaged within a partial set of orthodontic brackets 808′. Each engagement block is received within its corresponding bracket.

Orthodontic prescription values may be built into the brackets 808, such that the engagement blocks of the arch wire are aligned relative to core wire 802 so that the blocks provide no torque, rotation, or angulation prescription values. Rather, these prescription values may be built into the bracket slots. Alternatively, the prescription values may be built into the engagement blocks 804 and 804′ so that the arch wire may be used with a set of “zero angle” brackets, in which the brackets include no torque, rotation, or angulation values. A combination system is also possible, in which the torque, rotation, and angulation values of the prescription are shared between the engagement blocks and brackets. Exemplary prescriptions that may be built into the brackets and/or arch wire include MST, Roth, Bioprogressive/Hilgers, or combinations thereof. Further disclosure relative to systems in which the prescription values are built into the engagement blocks is found in a U.S. Patent Application Ser. No. 61/219,840 entitled “ORTHODONTIC ARCH WIRE HAVING BUILT IN PRESCRIPTION FEATURES”, filed Jun. 24, 2009, as well as U.S. Patent Application Ser. No. 61/297,348 entitled “ORTHODONTIC ARCH WIRE HAVING BUILT IN PRESCRIPTION FEATURES”, filed Jan. 22, 20010. Each of the above patent applications are incorporated herein by specific reference.

The individually customized low force orthodontic arch wires may be manufactured by any of various methods. For example, manufacture may be accomplished by bonding separately molded or machined engagement blocks to one or more core wires (e.g., this may be accomplished perhaps even chair side by the practitioner). In another embodiment, the low force orthodontic arch wires may be formed through molding the arch wire so as to include engagement blocks. In one example, injection molding with metal (e.g., LIQUID METAL ALLOY) can be used to form (i.e., mold) appropriately positioned engagement blocks onto one or more previously formed core wires that are run through the mold as a secondary operation. In another method, injection molding can be used to integrally mold the core wire(s) having appropriately positioned engagement blocks connected by molded “wire” sections. In other words, the core wire and engagement blocks are molded together as a single integral piece in a single molding step. In such an embodiment, the engagement blocks may be molded having occusal-gingival width dimensions configured for insertion into an orthodontic bracket. For example, the width may be approximately equal to the 0.022 inch or 0.018 inch slot width, or may be somewhat less so as to provide a desired degree of play (as shown in FIG. 7A). The molded interconnecting core wire sections are molded so as to have smaller, wire-like dimensions (e.g., preferably about 0.1 mm to about 0.25 mm).

Additional discussion of injection molding orthodontic apparatuses with liquid metal alloys can be found in U.S. patent application Ser. No. 12/488,144 entitled “MOLD ASSEMBLY APPARATUS AND METHOD FOR MOLDING METAL ARTICLES”, filed 19 Jun. 2009; and U.S. patent application Ser. No. 12/488,076 entitled “ORTHODONTIC BRACKETS HAVING A BENDABLE OR FLEXIBLE MEMBER FORMED FROM AMORPHOUS METALLIC ALLOYS”, filed 19 Jun. 2009, each of which is incorporated herein by specific reference.

In another exemplary method, the engagement blocks and the core wire sections can be formed from a single piece of metal, such as a billet. The billet of metal (e.g., initially a rectangular metal bar) can be formed by drawing, extrusion, injection molding, or another technique known in the art. In one embodiment, engagement blocks and core wire sections can be formed from a billet of metal using a machining process, such as micromachining or electrical discharge machining, and/or a chemical etching process to remove metal from the billet so as to shape and form the engagement blocks and core wire.

Manufacturing an arch wire from a billet of metal may be one relatively easy method of manufacturing the custom arch wires. For example, basic core wires can be machined from a straight or substantially straight billet of metal so as to have the appropriate customized length and the arch wire then can be placed into a mold or jig where it is bent into its final shape, and then the arch wire is heat set. In yet another method of manufacture, the arch wire including the engagement blocks may be built up much like a silicon chip is formed using a microfabrication process. The EFAB® process developed by Microfabrica, Inc. of Van Nuys, California is one example of a microfabrication process that can be employed. EFAB® microfabrication technology can be used to create complex, three-dimensional, micron-precision metal structures with unprecedented design flexibility. In the EFAB® process, a ceramic substrate is plated over by laying down a first metal material followed by subsequent layers of a second metal material. The first metal material and the second metal material can be any of a variety of materials which may be electrodeposited or depositable in some other manner. Examples of metals that may comprise the first layer include nickel, copper, silver, gold, nickel-phosphorous, nickel-cobalt, and alloys thereof. Similarly, the second metal material may take a variety of forms (e.g., copper, zinc, tin, and alloys thereof). In some manufacturing methods the first metal material is or includes nickel and the second metal material is or includes copper. The layers are built up much like semiconductor chip manufacture to create desired structures. For example, the EFAB® process can be used to build up layers that define the core wire and the engagement blocks having the desired size.

Additional discussion of the EFAB® process can be found in U.S. Pat. No. 6,027,630 entitled “METHOD FOR ELECTROCHEMICAL FABRICATION” and U.S. Pat. No. 7,384,530 entitled “METHODS FOR ELECTROCHEMICALLY FABRICATING MULTI-LAYER STRUCTURES INCLUDING REGIONS INCORPORATING MASKLESS, PATTERNED, MULTIPLE LAYER THICKNESS DEPOSITIONS OF SELECTED MATERIALS,” each of which is incorporated herein by specific reference.

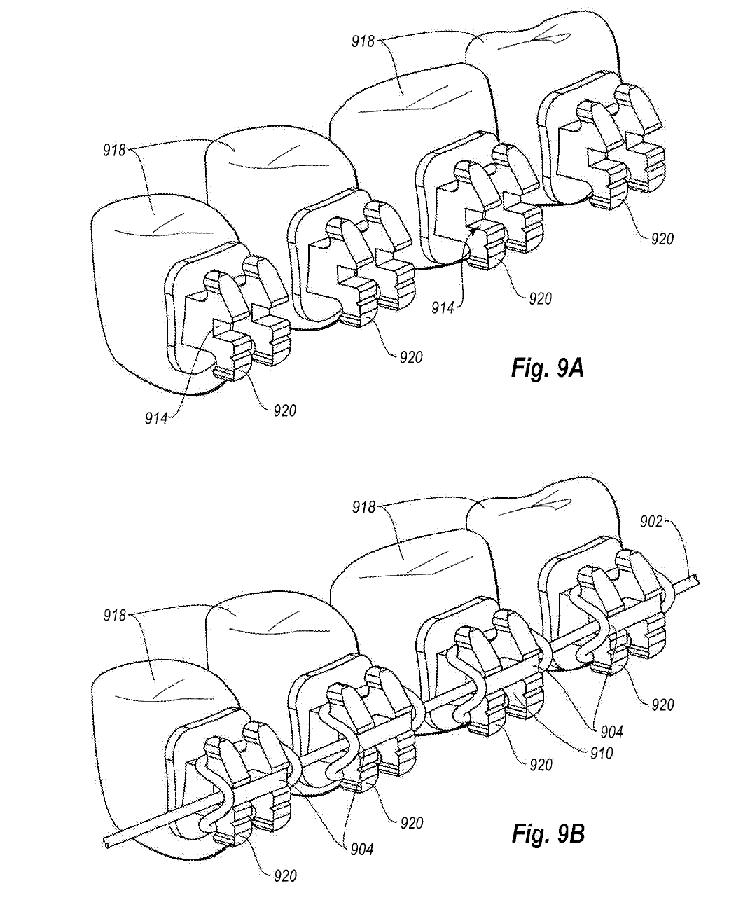

FIGS. 9A and 9B illustrate an exemplary method of using the inventive custom fabricated low force arch wires according to the invention. FIG. 9A shows a plurality of teeth 918 to which orthodontic brackets 920 have been bonded. As illustrated, the orthodontic brackets 920 are twin brackets. However, it is to be understood that any type of orthodontic bracket or combination of brackets (e.g., non self-ligating and/or self-ligating) may be used with the inventive custom low force arch wires.

As shown in FIG. 9B, an orthodontic arch wire 902 having engagement blocks 904 is inserted into the arch wire slots 914 of brackets 920. Thereafter, the practitioner attaches an appropriate ligature 910 over each bracket 920 so as to retain to the arch wire 902 and the engagement blocks 904 within the bracket slots 914. According to one embodiment, the arch wire 902 has shape memory and at least some of the engagement blocks 904 have prescription values for torque, rotation, and/or angulation built into them. Alternatively, the prescription torque, angulation, and rotation values may be built into the bracket slots/bases or the prescription may be shared between the blocks and bracket slots/bases. In each such case, it may not be necessary for the practitioner to do anything additional at this stage.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of manufacturing a customized orthodontic arch wire, comprising:
obtaining a physical or electronic custom model of a patient's dental arch;
based on the physical or electronic model of the patient's dental arch, determining a corrected, final position of the patient's teeth to which orthodontic brackets are to be attached;
providing a core wire having shape memory, the core wire extending between a first end and a second end, the core wire having a cross-sectional width;
providing a plurality of bracket engagement blocks to be disposed along the core wire for placement into arch wire slots of corresponding orthodontic brackets, the blocks having cross-sectional widths that are greater than the cross-sectional width of the core wire so as to provide increased engagement during use between the blocks and slots of corresponding brackets as compared to engagement that would otherwise be provided by the core wire within an arch wire slot in the absence of the blocks;
determining the length of the core wire by reference to the custom model of the patient's dental arch;
based on the corrected, final position of the patient's teeth to which orthodontic brackets are to be attached, determining a position along the length of the core wire for each corresponding bracket engagement block; and
positioning the plurality of engagement blocks in the determined position along the length of the core wire.

2. A method as recited in claim 1, wherein the model of the patient's dental arch is obtained by taking a physical impression of the patient's dental arch and forming a physical custom model from the physical impression.

3. A method as recited in claim 1, wherein the model of the patient's dental arch is obtained by electronically scanning the patient's dental arch and creating an electronic model of the patient's dental arch from electronic scanning data.

4. A method as recited in claim 1, wherein an engagement block corresponding to a tooth position is omitted along the length of the core wire.

5. A method as recited in claim 1, wherein a length of each engagement block is customized by reference to the custom model of the patient's dental arch.

6. A method as recited in claim 1, wherein each engagement block is fixedly placed at a customized predetermined position along the length of the core wire by crimping the block to the core wire.

7. A method as recited in claim 1, wherein each engagement block is fixedly placed at a customized predetermined position along the length of the core wire by welding or brazing the block to the core wire.

8. A method as recited in claim 1, wherein the core wire is substantially round in cross-section.

9. A method as recited in claim 1, wherein the core wire and the engagement blocks are formed of a shape-memory nickel-titanium alloy.

10. A method as recited in claim 1, wherein at least some of the engagement blocks are square or rectangular in cross-section so as to be capable of applying torquing forces to corresponding orthodontic brackets.

11. A method as recited in claim 10, wherein some of the engagement blocks are round in cross-section.

12. A method as recited in claim 1, wherein at least some of the engagement blocks are round in cross-section.

13. A method as recited in claim 1, wherein the engagement blocks are aligned with the core wire so that the engagement blocks provide no torque, no rotation, and no angulation to a patient's teeth.

14. A method as recited in claim 1, wherein the engagement blocks are aligned with the core wire so that the engagement blocks do provide at least one of torque, rotation, or angulation to a patient's teeth.

15. A method of fabricating a customized integral low force orthodontic arch wire comprising a core wire having shape memory and a plurality of bracket engagement blocks, the blocks and core wire being formed of a single integral piece of material, the method of manufacture comprising:
obtaining a physical or electronic custom model of a patient's dental arch;
based on the physical or electronic custom model of the patient's dental arch, determining a corrected, final position of the patient's teeth to which orthodontic brackets are to be attached;
determining the length of the core wire by reference to the custom model of the patient's dental arch;
based on the corrected, final position of the patient's teeth to which orthodontic brackets are to be attached, determining a position along the length of the core wire for each corresponding bracket engagement block, the blocks having cross-sectional widths that are greater than the cross-sectional width of the core wire so as to provide increased engagement during use between the blocks and slots of corresponding brackets as compared to engagement that would otherwise be provided by the core wire within an arch wire slot in the absence of the blocks were absent; and
manufacturing the customized low force orthodontic arch wire by forming the core wire and the plurality of engagement blocks along the core wire in their predetermined positions.

16. A method of manufacture as recited in claim 15, wherein the core wire is formed by injection molding with metal and the engagement blocks are formed onto the core wire as a secondary injection molding operation.

17. A method of manufacture as recited in claim 15, wherein the engagement blocks and the core wire are integrally formed as a single integral piece.

18. A method of manufacture as recited in claim 17, wherein the engagement blocks and the core wire are integrally molded as a single piece of metal.

19. A method of manufacture as recited in claim 17, wherein the engagement blocks are formed by removing material adjacent to the core wire during manufacture.

20. A method of manufacture as recited in claim 19, wherein adjacent material is removed by a machining process.

21. A method of manufacture as recited in claim 19, wherein adjacent material is removed by a chemical etching process.

22. A customized low force orthodontic arch wire, comprising:
a core wire having shape memory, the core wire extending along a generally curved arch wire axis between a first end and a second end, the core wire having a first cross-sectional width and a length and curvature corresponding to a length and curvature of a particular patient's dental arch; and
a plurality of spaced-apart, bracket engagement blocks disposed along the core wire for placement into arch wire slots of corresponding orthodontic brackets, wherein spacing between adjacent engagement blocks corresponds to a patient's particular spacing between adjacent teeth so that each engagement block is positioned along the core wire so as to be custom aligned with a tooth to which it corresponds;
the engagement blocks having a second cross-sectional width that is greater than the first cross-sectional width of the core wire so as to provide increased engagement between the enlarged engagement block and an arch wire slot of a corresponding orthodontic bracket as compared to engagement that would otherwise be provided by the core wire within an arch wire slot in the absence of the engagement blocks were not present.
